(19) United States
(12) Patent Application Publication
(10) Pub. No.: US 2013/0279168 A1
(43) Pub. Date: Oct. 24, 2013

(54) LIGHT-EMITTING DIODE LUMINOUS DEVICE

(71) Applicant: CHU-KENG LIN, Chu-Nan (TW)

(72) Inventor: CHU-KENG LIN, Chu-Nan (TW)

(73) Assignee: FOXSEMICON INTEGRATED TECHNOLOGY, INC., Chu-Nan (TW)

(21) Appl. No.: 13/479,277

(22) Filed: May 24, 2012

(30) Foreign Application Priority Data
Apr. 23, 2012 (TW) 101114345

(51) Int. Cl. F21V 29/00

(52) U.S. Cl. 362/249.02

(57) ABSTRACT

An LED luminous device comprises a fin assembly, heat pipes, a printed circuit board located on the fin assembly and LEDs arranged on the printed circuit board. The fin assembly defines elongated through holes therein. Each heat pipe comprises a first pipe and a plurality of second pipes communicated with the first pipe. The first pipe comprises a straight pipe and two extending pipes extending from two ends of the straight pipe, and the plurality of second pipes are located between the two extending pipes and parallel to the extending pipes. The plurality of second pipes is communicated with the straight pipe. The extending pipes and the second pipes are inserted into the elongated through holes of the fin assembly.

### BACKGROUND

1. Technical Field

The present disclosure relates to a luminous device, and more particularly, to a light emitting diode (LED) luminous device.

2. Description of Related Art

LEDs have been widely promoted as a light source of electronic devices owing to many advantages, such as high luminosity, low operational voltage and low power consumption. In practice, the LEDs generate a large amount of heat during operation. If the heat is not timely removed, the luminous efficiency will be reduced, and life of the LEDs will be shortened significantly. Typically, a heat dissipation device is provided to take away the heat generated by the LEDs to make sure that the LED luminous device works normally under a proper temperature. The heat dissipation device generally includes a fin assembly. However, the ordinary fin assembly is difficult to satisfy heat dissipation requirement as power of the LEDs increases.

Therefore, an LED luminous device capable of overcoming the above described shortcoming is desired.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an assembled, isometric view of an LED luminous device in accordance with an embodiment of the present disclosure.

FIG. 2 is an inverted view of the LED luminous device of FIG. 1.

FIG. 3 is an enlarged, right-side view of the LED luminous device of FIG. 1.

FIG. 4 is an isometric view of a fin of the LED luminous device of FIG. 2.

FIG. 5 is an exploded view of the LED luminous device of FIG. 1.

### DETAILED DESCRIPTION

Embodiment of the present LED luminous device will now be described in detail below and with reference to the drawings.

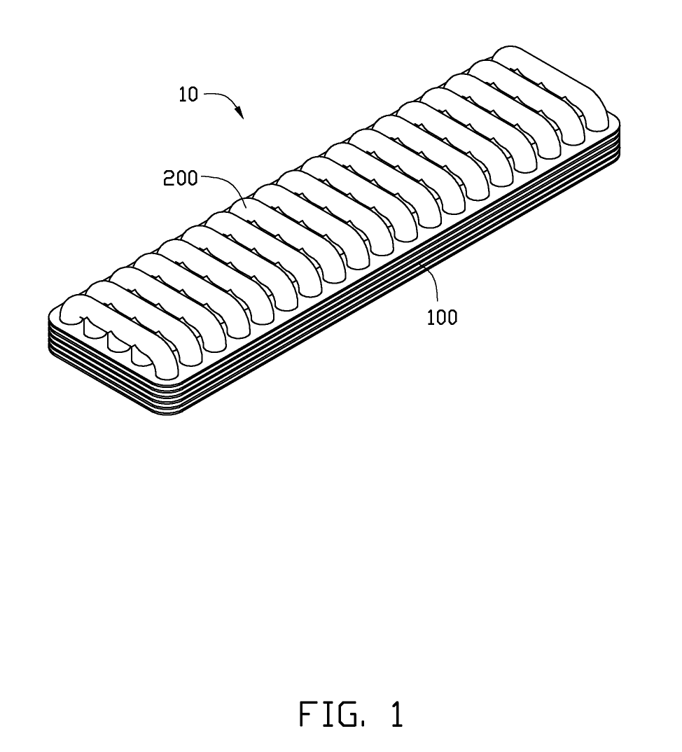

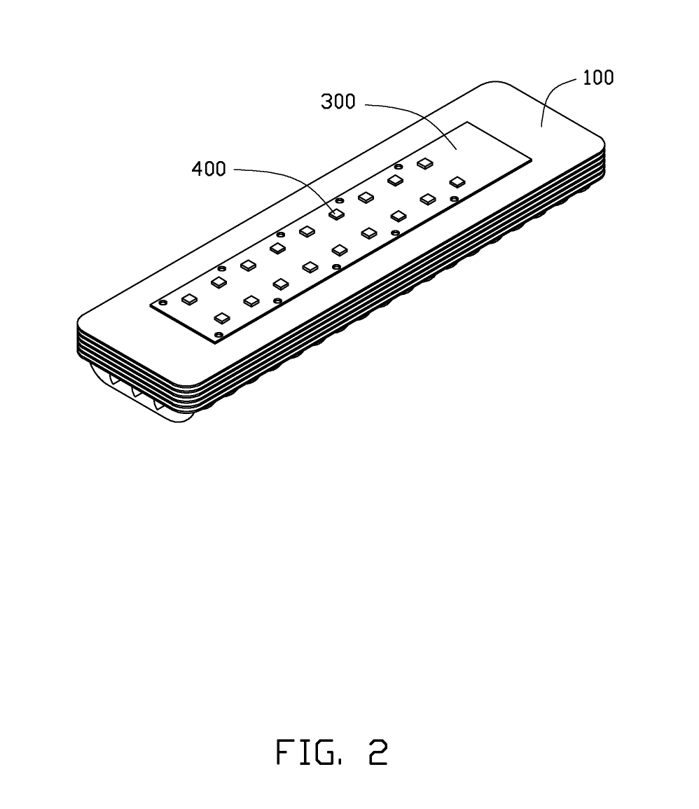

Referring to FIGS. 1 and 2, an LED luminous device 10 in accordance with an exemplary embodiment of the present disclosure includes a fin assembly 100, a plurality of heat pipes 200 inserted into the fin assembly 100, a printed circuit board 300 attached to a bottom of the fin assembly 100, and a plurality of LEDs 400 located on a bottom of the printed circuit board 300.

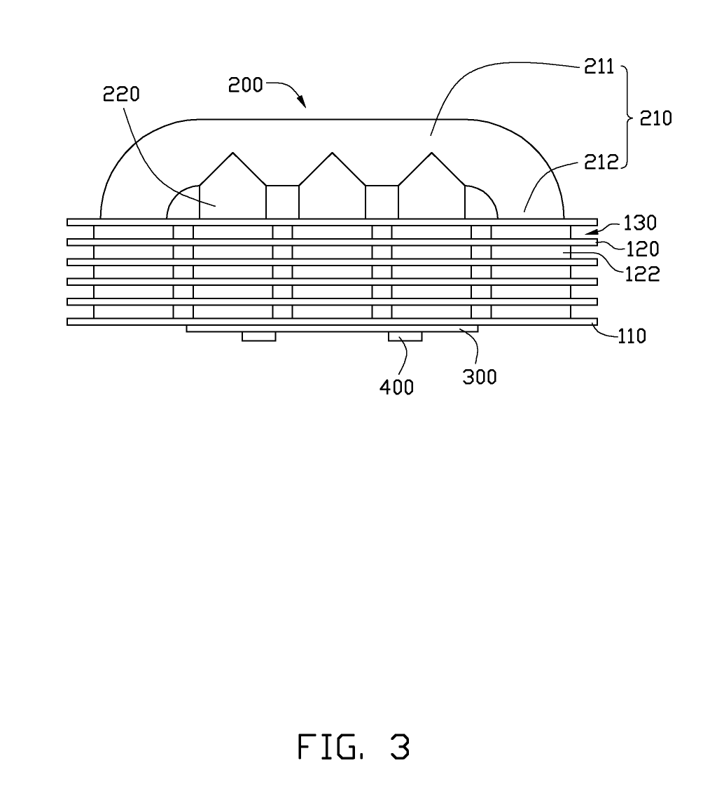

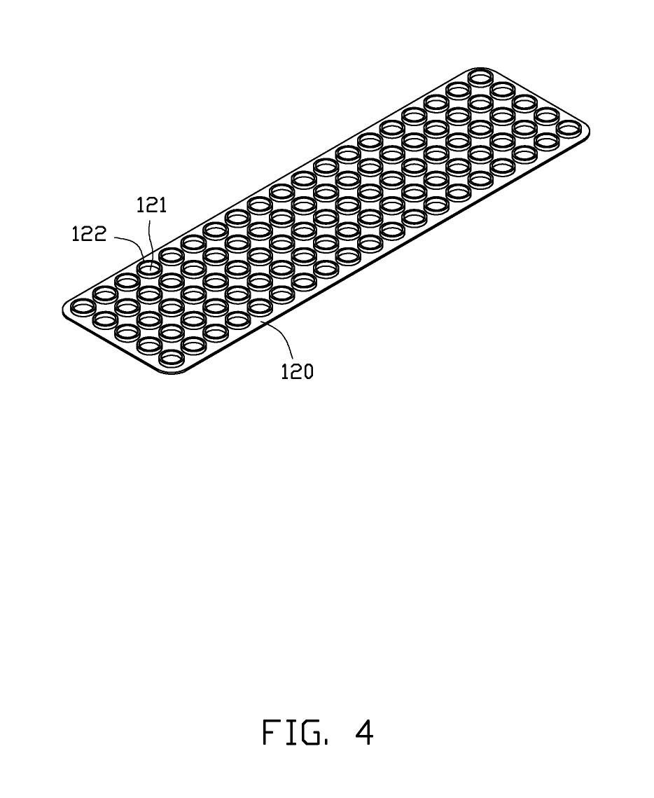

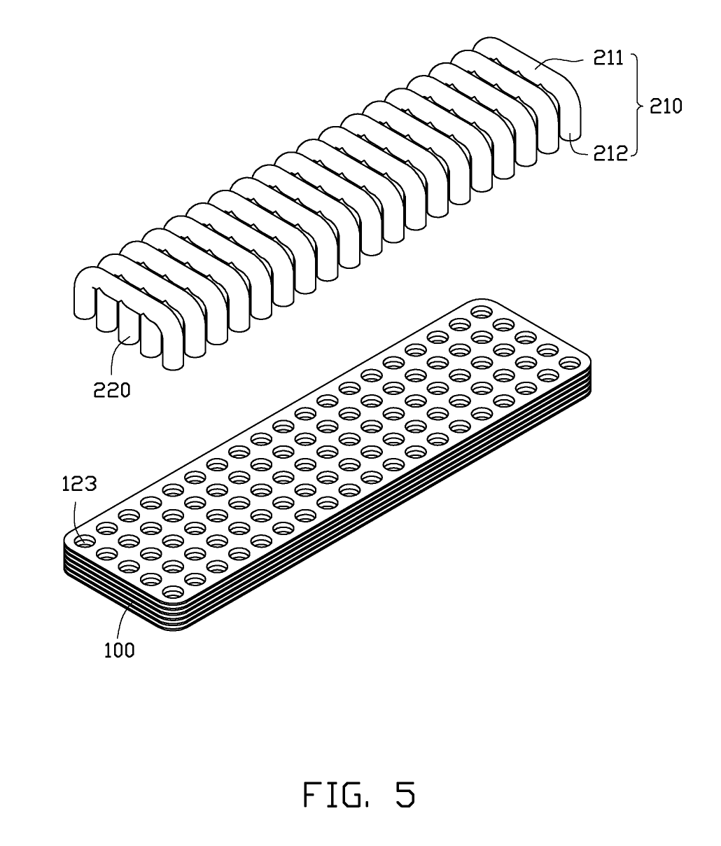

Also referring to FIGS. 3-5, the fin assembly 100 includes a base 110 and a plurality of stacked fins 120 located on the base 110. The base 110 and the fins 120 are all rectangular, and made of aluminum. Each of the fins 120 defines a plurality of through holes 121 arranged in a matrix array, and a diameter of each through hole 121 is 5-10 millimeters (mm). In this embodiment, the fins 120 form a plurality of annular walls 122 extending downwardly from a bottom surface thereof along edges of the through holes 121, respectively. The bottom surface of each fin 120 is close to the base 110, and bottom ends of the annular walls 122 of the bottommost fin 120 abut on the base 110. When the fins 120 are stacked together, the through holes 121 of one fin 120 align with the through holes 121 of an adjacent fin 120, respectively. The adjacent fins 120 are spaced from each other by the annular walls 122, so a heat dissipation channel 130 is defined therebetween. The annular walls 122 are stacked together and the through holes 121 are aligned with each other thereby to form a plurality of elongated through holes 123 in the fin assembly 100.

Each of the heat pipes 200 is filled with cooling liquid, and includes a first pipe 210 and a plurality of second pipes 220 communicated with the first pipe 210. The first pipe 210 includes a straight, horizontal pipe 211 and two extending pipes 212 extending downwardly from two opposite ends of the straight, horizontal pipe 211, respectively. In this embodiment, the two extending pipes 212 are perpendicular to the straight, horizontal pipe 211, and the second pipes 220 are located between the two extending pipes 212, and parallel to the two extending pipes 212. The second pipes 220 are communicated with the straight, horizontal pipe 211. The first pipe 210 and the plurality of second pipes 220 of each heat pipe 200 cooperatively form a comb-shaped configuration.

A sum of a number of the extending pipes 212 and a number of the second pipes 220 of each heat pipe 200 is equal to that of the through holes 121 of one fin 120 in each row. The extending pipes 212 and the second pipes 220 are inserted into the corresponding through holes 121 in each row, and the straight, horizontal pipe 211 is located above the fin assembly 100. When the fin assembly 100 and the plurality of heat pipes 200 are assembled together, the straight, horizontal pipes 211 are located over a top of the fin assembly 100 and spaced from each other along a length direction of the fin assembly 100, with the extending pipes 212 and the second pipes 220 being fitted into the elongated through holes 123 of the fin assembly 100. Since the heat pipe 200 is filled with cooling liquid, for example, water, heat generated by the LEDs 400 can be quickly absorbed by the heat pipes 200 via the base 110 and then dissipated to the surrounding environment by the fin assembly 100, wherein air convection can be effectively achieved by air flowing through the channels 130 between the fins 120. Each heat pipe 200 can have an evaporating part located at a bottom end of each of the extending pipes 212 and the second pipes 220 in engagement with the base 110, at which the cooling liquid evaporates into vapor after absorbing heat from the LEDs 400. Furthermore, each heat pipe 200 can have a condensing part located at a side wall of each of the extending pipes 212 and the second pipes 220 which is in engagement with the fins 120. At the condensing part, the vapor releases the heat and condenses back to the cooling liquid.

The printed circuit board 300 is metal core printed circuit board, and located on the base 110 of the fin assembly 100. The printed circuit board 300 and the fins 120 are located on opposite sides of the base 110, respectively. The LEDs 400 are located on the printed circuit board 300.

During operation of the LED luminous device 10, the heat generated by the LEDs 400 is transferred to the base 110 of the fin assembly 100. The extending pipes 212 and the second pipes 220 of the heat pipes 200 absorb the heat from the base 110, and transfer the heat to the fins 120 quickly and evenly. As such, the heat dissipation efficiency is improved. Additionally, each fin 120 forms a plurality of annular walls 122, and the annular walls 122 are stacked together to form the plurality of elongated through holes 123. The extending pipes 212 and the second pipes 220 of the heat pipes 200 are inserted into the elongated through holes 123, thereby contacting the annular walls 122 sufficiently. Due to that contacting area between the heat pipes 200 and the fins 120 is increased, the heat dissipation efficiency is improved thereby.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An LED luminous device, comprising:
a fin assembly including a plurality fins stacked over each other and defining a plurality of through holes therein;
a plurality of heat pipes, each heat pipe comprising a first pipe and a plurality of second pipes in communication with the first pipe, the first pipe comprising a straight pipe and two extending pipes respectively extending from two ends of the straight pipe, the second pipes being located between the two extending pipes and parallel to the extending pipes, the second pipes in communication with the straight pipe, the extending pipes and the second pipes being inserted into the through holes of the fin assembly;
a printed circuit board located on the fin assembly and in thermal connection with the heat pipes and the fin assembly; and
a plurality of LEDs arranged on the printed circuit board.

2. The LED luminous device of claim 1, wherein the two extending pipes are perpendicular to the straight pipe.

3. The LED luminous device of claim 2, wherein the fin assembly further comprises a base and the plurality of stacked fins being located over the base, the printed circuit board and the fins being respectively located on opposite sides of the base, and the printed circuit board being attached to a bottom of the base.

4. The LED luminous device of claim 3, wherein each of the fins defines a plurality of through bores therein and forms a plurality of annular walls extending downwardly from a bottom surface of the each fin along edges of the through bores, respectively, and the through holes are defined by the annular walls of the fins stacked together and aligned with each other.

5. The LED luminous device of claim 4, wherein a diameter of each through bore is 5-10 mm.

6. The LED luminous device of claim 3, wherein bottom ends of the extending pipes and the second pipes act as an evaporation section, side surfaces of the extending pipes and the second pipes act as an condensation section of each heat pipe, the bottom ends contact the base to absorb heat generated by the LEDs, and the side surfaces transfer the heat to the fin assembly.

7. The LED luminous device of claim 3, wherein the base and the fins are made of aluminum.

8. The LED luminous device of claim 1, wherein the first pipe and the plurality of second pipes cooperatively form a comb-shaped configuration.

9. The LED luminous device of claim 1, wherein the printed circuit board is a metal core printed circuit board.

10. An LED luminous device, comprising:
a printed circuit board with a plurality of LEDs arranged thereon;
a fin assembly located on the printed circuit board opposite to the LEDs, the fin assembly comprising a base thermally connecting with the printed circuit board and a plurality of fins on the base, the fins defining a plurality of through holes therein; and
at least one heat pipe comprising a first pipe and a plurality of second pipes in communication with the first pipe, the first pipe comprising a straight pipe and two extending pipes respectively extending from opposite ends of the straight pipe, the second pipes in communication with the straight pipe, the extending pipes and the second pipes being inserted into the through holes with end surfaces thereof in contact with the base and side surfaces thereof in contact with the fin assembly.

11. The LED luminous device of claim 10, wherein the two extending pipes are perpendicular to the straight pipe.

12. The LED luminous device of claim 11, wherein each of the fins defines a plurality of through bores therein and forms a plurality of annular walls extending from a bottom surface of the each fin along edges of the through bores toward the base, respectively, and the through holes are defined by the annular walls stacked together.

13. The LED luminous device of claim 12, wherein a diameter of each through bore is 5-10 mm.

14. The LED luminous device of claim 10, wherein the first pipe and the plurality of second pipes cooperatively form a comb-shaped configuration.

15. The LED luminous device of claim 10, wherein the printed circuit board is a metal core printed circuit board.

16. The LED luminous device of claim 10, wherein the base and the fins are made of aluminum.

17. The LED luminous device of claim 10, wherein a gap is between two adjacent fins for facilitating air convection through the fin assembly.

18. The LED luminous device of claim 10, wherein cooling liquid is filled in the at least one heat pipe.

19. The LED luminous device of claim 18, wherein the cooling liquid is water.

20. The LED luminous device of claim 10, wherein the at least one heat pipe comprises a plurality of heat pipes which are spaced from each other along a length direction of the fin assembly.
